(19) United States
(12) Patent Application Publication
(10) Pub. No.: US 2024/0375252 A1
(43) Pub. Date: Nov. 14, 2024

(54) EJECTION MECHANISMS FOR A POWER TOOL

(71) Applicant: Milwaukee Electric Tool Corporation, Brookfield, WI (US)

(72) Inventors: Mitchell Gibson, Brookfield, WI (US); Kyle Marten, Brookfield, WI (US); Benjamin Farley, Brookfield, WI (US)

(21) Appl. No.: 18/656,180

(22) Filed: May 6, 2024

Related U.S. Application Data
(60) Provisional application No. 63/500,892, filed on May 8, 2023.

(51) Int. Cl. B25B 23/00; B25B 21/00

(52) U.S. Cl. CPC B25B 23/0057; B25B 21/002

(57) ABSTRACT

A power tool includes an ejection mechanism configured to eject an end of a fastener. The ejection mechanism includes an ejection rod that is actuated by a motor of a power tool to move from a first position to a second position to eject the end of the fastener. Following ejection of the end of the fastener, the ejection rod is returned to the first position by a return spring.

### CROSS-REFERENCE TO RELATED APPLICATIONS

This application claims the benefit of U.S. Provisional Patent Application No. 63/500,892, filed May 8, 2023, which is herein incorporated by reference in its entirety.

### BACKGROUND

Tension control (TC) and/or shear wrenches are typically used in the manufacture of high-strength and/or high-load buildings (e.g., metal buildings, skyscrapers, etc.) to control the tension (e.g., torque, tightness) of a fastener. In one example, TC wrenches are configured to shear-off (e.g., remove) an end and/or spline portion of a TC fastener after reaching a predetermined tension. The spline portion of the fastener can be ejected from the via an ejection mechanism.

### SUMMARY

Examples of an ejection mechanism for a power tool, such as a tension control (TC) and/or shear wrench are disclosed herein. In some examples, an ejection mechanism can include an ejection rod having a threaded shaft and a cam plate configured to be selectively actuated via a trigger between a first position and a second position. A pawl can be engaged with the cam plate. The pawl can be configured to disengage from the threads of the ejection rod when the cam plate is in the first position and to engage with the threaded shaft of the ejection rod when the cam plate is in the second position. Engagement of the pawl with the ejection rod can cause the ejection rod to be axially actuated from a first axial position to a second axial position.

In another example, embodiments of the invention provide a power tool, such as a tension control (TC) and/or shear wrench. The power tool can include an ejection mechanism having an ejection rod with a first cam face configured to engage with a second cam face. The second cam face can be coupled to a one-way clutch to enable unidirectional rotation of the second cam face. The ejection mechanism can further include a biasing element configured to bias the first cam face into contact with the second cam face. Rotation of the ejection rod in a first direction can rotate both the first cam face and the second cam face together. Rotation of the ejection rod in a second direction locks rotation of the second cam face via the one-way clutch and allows rotation of the first cam face to cause the ejection rod to axially actuate.

In another example, embodiments of the invention provide a power tool, such as a tension control (TC) and/or shear wrench. The power tool can include an electric motor, an ejection mechanism, and an actuator. The ejection mechanism can include an ejection rod having threaded shaft with a first end and an opposite, second end, and a shuttle moveable between a first position and a second position. The shuttle can define a cutout having a threaded portion. The actuator can move the shuttle between the first position, where the threaded portion of the cutout is disengaged from the threaded shaft, and the second position, where the threaded portion of the cutout is engaged with the threaded shaft.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a cross-sectional view of one example of a power tool according to aspects of the present disclosure.

FIG. 2 is a detail view of an ejection mechanism of the power tool of FIG. 1, taken about line II-II.

FIG. 3 is a first side view of the ejection mechanism of the power tool of FIG. 1.

FIG. 4 is a second side view of the ejection mechanism of the power tool of FIG. 1.

FIG. 5 is a side view of the ejection mechanism of FIG. 3 when disengaged.

FIG. 6 is a cross-sectional view of the ejection mechanism of FIG. 3 when disengaged.

FIG. 7 is a side view of the ejection mechanism of FIG. 3 when engaged.

FIG. 8 is a cross-sectional view of the ejection mechanism of FIG. 3 when engaged.

FIG. 9 is a side view of the ejection mechanism of FIG. 3 when actuated.

FIG. 10 is a cross-sectional view of another example of an ejection mechanism for use with the power tool of FIG. 1 according to aspects of the present disclosure.

FIG. 11 is a side view of the ejection mechanism of FIG. 10 when disengaged.

FIG. 12 is a cross-sectional view of the ejection mechanism of FIG. 10 when engaged.

FIG. 13 is a side view of the ejection mechanism of FIG. 10 when engaged.

FIG. 14 is a side view of the ejection mechanism of FIG. 10 when actuated.

FIG. 15 is a cross-sectional view of another example of an ejection mechanism for use with the power tool of FIG. 1 according to aspects of the present disclosure.

FIG. 16 is a perspective view of the ejection mechanism of FIG. 15 in a first position.

FIG. 17 is a perspective view of the ejection mechanism of FIG. 16 in a second position.

FIG. 18 is a cross-sectional view of another example of an ejection mechanism for use with the power tool of FIG. 1 according to aspects of the present disclosure.

FIG. 19 is a detail view of the ejection mechanism of FIG. 18, taken about line XIX-XIX.

FIG. 20 is a perspective view of another example of an ejection mechanism for use with the power tool of FIG. 1 according to aspects of the present disclosure.

FIG. 21 is a first end view of the ejection mechanism of FIG. 20 in a first position.

FIG. 22 is a first end view of the ejection mechanism of FIG. 20 in a second position.

FIG. 23 is a side partial view of the power tool of FIG. 1 including another example of an ejection mechanism actuator according to aspects of the present disclosure.

FIG. 24 is a rear partial view of the power tool of FIG. 1 including the ejection mechanism actuator of FIG. 23.

FIG. 25 is a cross-sectional view of the power tool of FIG. 1 including the ejection mechanism actuator of FIG. 23.

FIG. 26 is a perspective view of a selector of the ejection mechanism actuator of FIG. 23.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The following detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

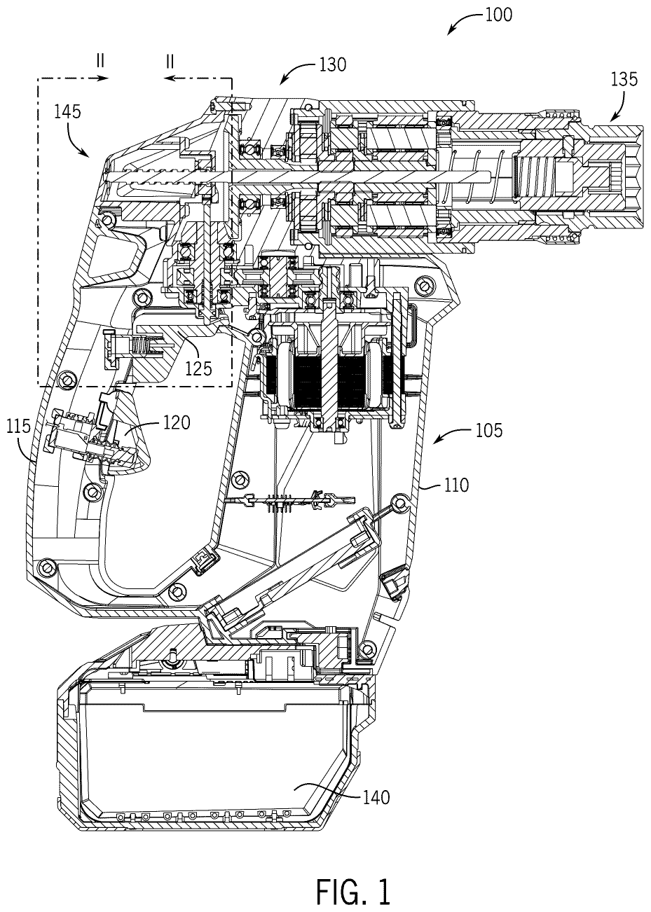

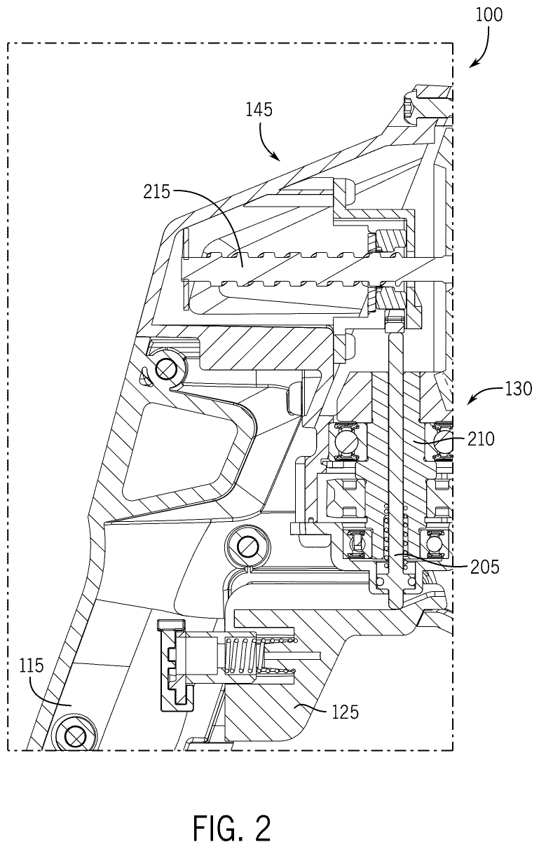

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

The disclosed ejection mechanism for a power tool will be described with respect to an example ejection mechanism for a shear wrench. However, it should be understood that any one or more example embodiments of the disclosed ejection mechanism could be incorporated in alternate forms of a power tool. Furthermore, it should be understood that one or more example embodiments of the disclosed ejection mechanism could be used outside of the context of a power tool and could more generally be used in a mechanism and/or mechanisms to secure one or more fasteners.

In one example, the ejection mechanism includes a motor-driven ejection rod, which is rotated by a splined connection to a planetary drivetrain of the tool. The ejection rod is actuated forward via threaded engagement with one or more pawls to eject a spline portion of a tension control (TC) bolt. The ejection rod is surrounded by a spring, which assists in biasing the ejection rod to return to the “home” position (e.g., a retracted position) after ejection of the spline. To eject the spline portion of the TC bolt, the pawls selectively engage with a threaded portion of the ejection rod (e.g., a shaft) via rotation of a cam in a first direction. The ejection rod is advanced via the threaded connection between the pawls and the ejection rod, which causes the spring to compress. The pawls then automatically disengage when a cap of the ejection rod contacts the cam to rotate the cam in the opposite direction, which allows the biasing force from the spring to return the ejection rod to the home position.

In another example, an ejection mechanism includes a motor-driven ejection rod, which is actuated forward via interaction between first cam face coupled to rotate with the ejection rod and second cam supported on a sprag bearing (e.g., a one-way clutch). The cam faces each include corresponding ramped and/or sloped portions, which lock together during rotation of the motor/drivetrain in a first direction. The sprag bearing is configured to allow the first and second cam faces to rotate together in the first direction. However, during rotation of the motor/drivetrain in a second, opposite, the sprag bearing locks the second cam face against rotation Correspondingly, the direction the ramped and/or sloped portions of the first and second faces interact (e.g., slide against one another) to axially displace the ejection rod (connected to the first cam face) to eject the spline portion of a tension control (TC) bolt. The ejection rod is further surrounded by a spring, which biases the ejection rod and first cam face to return to the “home” (e.g., retracted) position after ejection of the spline.

To eject the spline portion of the TC bolt, the motor/drivetrain is operated in the second direction via actuation of a button. When operating in the second direction, a one-way clutch (e.g., sprag clutch) catches the second cam face and prevents rotation of the second cam face so that the first cam face rotates relative to the second cam face. As a result, the first cam face continues to rotate, causing the corresponding sloped/ramped portions of the first and second cam faces to slide against one another, which axially displaces the ejection rod against the biasing force of the spring to eject the spline portion of the TC bolt. The axial displacement of the ejection rod causes the spring to be compressed. After the spline is ejected, the spring biases the ejection rod back into the “home” position.

FIG. 1 illustrates one example of a power tool 100 including an ejection mechanism 145. In one example, the power tool 100 may be a shear wrench (e.g., a TC wrench). The power tool 100 may include a housing 105 with a motor housing 110 and a handle 115. In one example, the housing 105 may be a clamshell type housing to enable replacement of one or more components of the housing by a user. In another example, the housing 105 may be a unitary housing (e.g., molded unitary body). The power tool 100 may be made from a variety of materials, such as polymeric material, metallic material, and/or other materials. In one example, the handle 115 may include one or more triggers. The triggers may be used to selectively control one or more functions of the power tool 100. For example, the triggers may control power, rotation, and/or other functions of the power tool 100. In one particular example, a primary trigger 120 (e.g., a first trigger) may be used to selectively enable power flow from a power supply 140 to a motor positioned within the motor housing 110. In one example, the power supply 140 may be a direct current (DC) power source, such as a battery. In another example, the power supply 140 may be an alternating current (AC) power source, such as power cord connected to a wall outlet. In other examples, the power supply 140 may include an inverter and/or a rectifier used to convert AC to DC power and/or DC to AC power. In one particular example, the power supply 140 may be a removable and rechargeable lithium-ion type battery.

In one example, the power tool 100 may include an output assembly 130 with an output end 135 located at a first end of the output assembly 130. In one example, the handle 115 may be located adjacent a second end of the output assembly 130, below the output assembly 130. In one example, the output end 135 may be powered by the motor and one or more gears within the output assembly 130. In one example, the output end 135 may be used to tighten a fastener. In one particular example, the output end 135 may include an outer socket and an inner socket. The outer socket and the inner socket may be configured to engage with a fastener to be tightened by the power tool 100. In one example, the outer socket is configured to engage with a first portion of the fastener (e.g., a nut) and the inner socket is configured to engage with a second portion of the fastener (e.g., an end and/or spline portion of the bolt). In one example, the motor and the output assembly 130 are configured to rotate the outer socket in a first direction and to rotate the inner socket in a second, opposite, direction. In one example, after the fastener is tightened to a desired torque (e.g., a torque that coincides with a desired tension in the fastener), the inner socket continues to rotate, which shears of a portion of the fastener (e.g., an end of the bolt). The sheared off portion of the fastener (e.g., a spline) may be ejected from the power tool 100 via the ejection mechanism 145.

In one example, the ejection mechanism 145 may be positioned adjacent the handle 115. For example, the ejection mechanism 145 may be locate at a second end of the output assembly 130 opposite of the output end 135. The ejection mechanism 145 may be controlled (e.g., activated and/or deactivated) via the use of the one or more triggers. In one particular example, a secondary trigger 125 (e.g., a second trigger) may be used to selectively actuate and/or activate the ejection mechanism 145. The ejection mechanism 145 may be powered by the motor and the gears as described previously. However, in other examples, a separate powertrain (e.g., one or more gears and/or a motor) may be used to power the ejection mechanism 145. In other examples, only a single trigger may be used to actuate both the output end 135 and the ejection mechanism 145.

FIG. 2 shows an example of a portion of the power tool 100 including the ejection mechanism 145. As can be seen, the ejection mechanism 145 may be positioned adjacent and/or at the second end of the output assembly 130, above the handle 115. In one example, the secondary trigger 125 includes a linkage shaft 205, which passes through an opening defined by a jackshaft 210, which may be a component of the powertrain of the power tool 100. The linkage shaft 205 may actuate one or more components of the ejection mechanism 145 to enable rotation and/or axial movement of an ejection rod 215. The ejection rod 215 may be configured to contact a splined portion and/or end of a fastener held within the inner socket of the output end 135 to eject the splined portion from the inner socket. In one example, the ejection rod 215 may extend from the first end to the second end of the output assembly 130 of the power tool 100. In other examples, the ejection rod 215 may extend only a portion of the overall length of the output assembly 130 of the power tool 100.

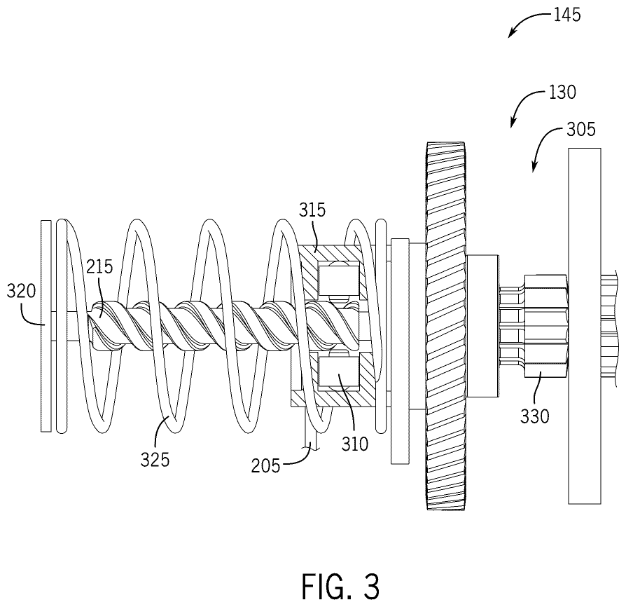

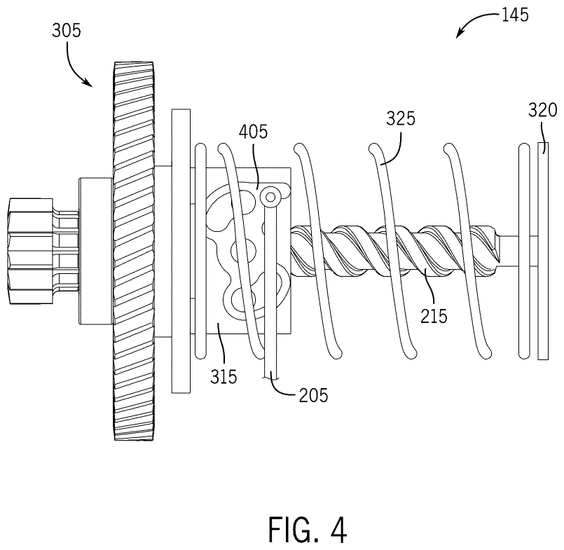

FIGS. 3 and 4 show first and second side views of the ejection mechanism 145. In one example, the ejection mechanism 145 may be actuated and/or driven by one or more gears 305 within the power tool 100 (e.g., via a transmission configured to transmit torque from a motor to the output end 135). For example, the ejection mechanism 145 may be connected to one or more gears 305 of the output assembly 130 via the ejection rod 215. In one particular example, the ejection rod 215 is connected to the one or more gears via a splined connection such that rotation of the gears generates corresponding rotation in the ejection rod 215. For example, the ejection rod 215 may be connected to a splined gear 330, which is configured to transmit rotation into the ejection rod 215. In one particular example, the splined gear 330 may be rotated by one or more planetary geartrains within the output assembly 130. In one example, the ejection rod 215 of the ejection mechanism 145 rotates freely with the gears 305 when the ejection mechanism 145 is disengaged (e.g., secondary trigger 125 is not actuated). When the ejection mechanism 145 is disengaged, one or more pawls 310 held within a cam assembly 315 are in a first position (e.g., not in contact with the ejection rod 215). Thus, the ejection rod 215 is able to rotate freely with the gears 305 without axial movement of the ejection rod.

To facilitate axial movement of the ejection rod 215 (e.g., to eject a portion of the fastener), the one or more pawls 310 are actuated via a cam plate 405. In one example, the ejection mechanism 145 may include only a single pawl 310. However, in other example, the ejection mechanism 145 may include more than one pawl 310, such as two, three, four, and/or more pawls 310. The cam plate 405 may be secured to the cam assembly 315 and in mechanical communication with the pawls 310. In one example, the cam plate 405 is connected to the linkage shaft 205 such that actuation of the linkage shaft 205 (via the secondary trigger 125) engages and/or disengages the pawls 310 from the ejection rod 215. In one example, actuation of the pawls 310 engages the ejection rod 215, which converts some of the rotational motion of the ejection rod (e.g., via the gears/motor) into axial movement of the ejection rod 215. The ejection rod 215 may actuate axially until the end and/or splined portion of the fastener is ejected from the power tool 100 and/or until a head 320 of the ejection rod moves the cam plate 405 into the disengaged position.

To return the ejection rod 215 to a home position (e.g., position shown in FIG. 2) a biasing element 325 is between the head 320 (at a second end of the ejection rod 215) and the cam assembly 315. In one example, the biasing element 325 may be a spring, which in some cases, can positioned around the ejection rod 215. In other examples, the biasing element 325 may be an elastic material, such as rubber and/or another elastic material.

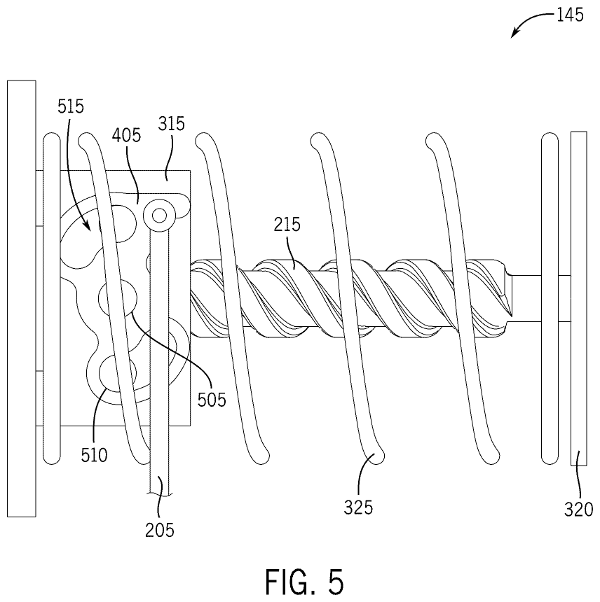

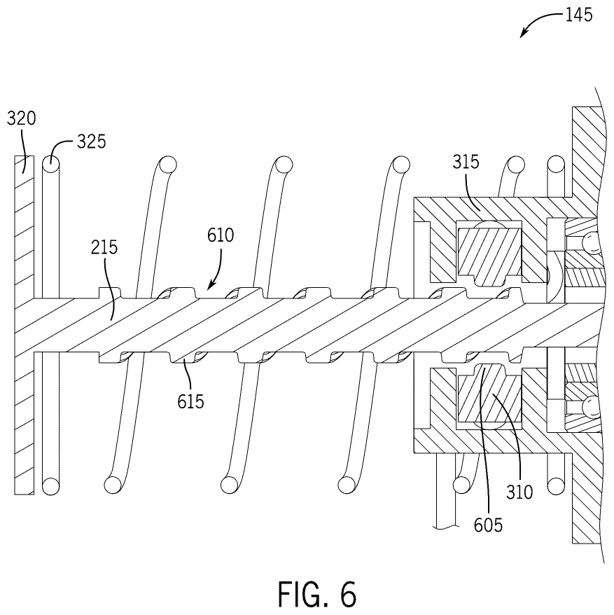

FIGS. 5 and 6 show examples of the ejection mechanism 145 in the disengaged position (e.g., the secondary trigger 125 is not actuated by a user). In the disengaged position, the pawls 310 are not in contact with the ejection rod 215. For example, one or more pawl pins 510 of the pawls 310 are in a first position within a slot 515 of the cam plate 405. In the disengaged position, the pawls 310, and more specifically a protrusion 605 of the pawls 310, is free from contact with the ejection rod 215. Thus, the ejection rod 215 is able to slide and/or rotate within the cam assembly 315 without contacting the protrusion 605 of the pawls 310. Thus, the ejection rod 215 may rotate freely without axial movement of the ejection rod 215. The protrusion 605 can be shaped in accordance with a thread 615 on the ejection rod 215. Thus, in the disengaged position, the protrusion 605 is out of engagement with the thread 615.

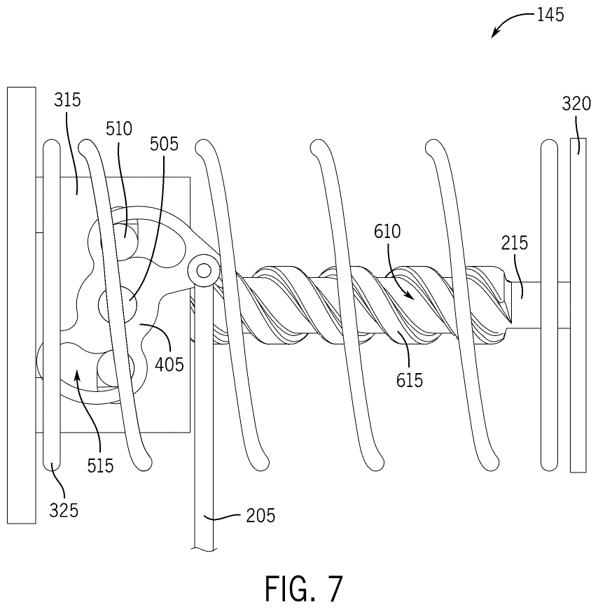

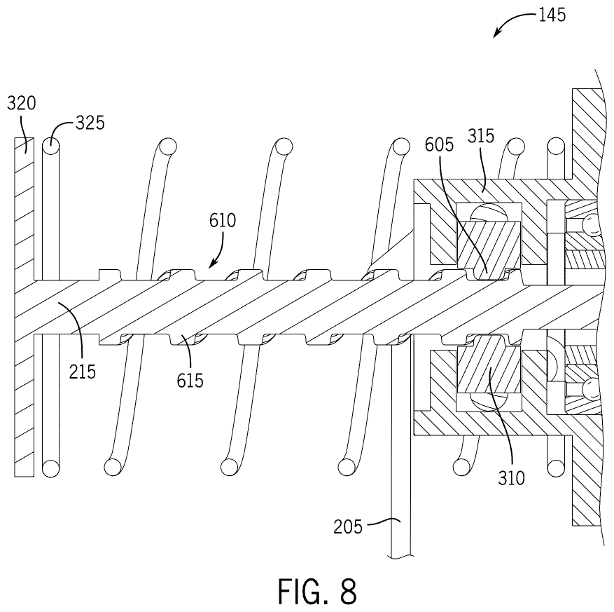

FIGS. 7 and 8 show examples of the ejection mechanism 145 in the engaged position (e.g., the secondary trigger 125 is actuated by a user), in which the pawls 310 are in contact with the ejection rod 215. To facilitate contact between the pawls 310 and the ejection rod 215, the cam plate 405 pivots about a pivot pin 505. As the cam plate 405 pivots about the pivot pin 505, the pawl pins 510 slide within the slot 515 defined by the cam plate 405 into a second position, which reduces a space and/or distance between the pawls 310 (e.g., a radial distance relative to the ejection rod 215). Thus, the protrusion 605 of the pawls 310 engages with a groove 610 defined by one or more threads 615 of the ejection rod 215. In one example, the threads 615 may be helical acme threads configured to facilitate axial movement of the ejection rod 215. However, in other examples, the threads 615 may define alternate shapes and/or patterns, such as square and/or other thread patterns.

As the ejection rod 215 rotates (e.g., is rotated by the gears/motor) the protrusion 605 follows the groove 610, which axially actuates the ejection rod 215 (e.g., towards the output end 135). During actuation of the ejection rod 215, the biasing element 325 may be compressed between the head 320 and the cam assembly 315, which generates an increasing biasing force within the biasing element 325 throughout actuation of the ejection rod 215. Thus, once the pawls 310 move from the engaged position to the disengaged position, the biasing element 325 may automatically return the ejection rod 215 to the home position.

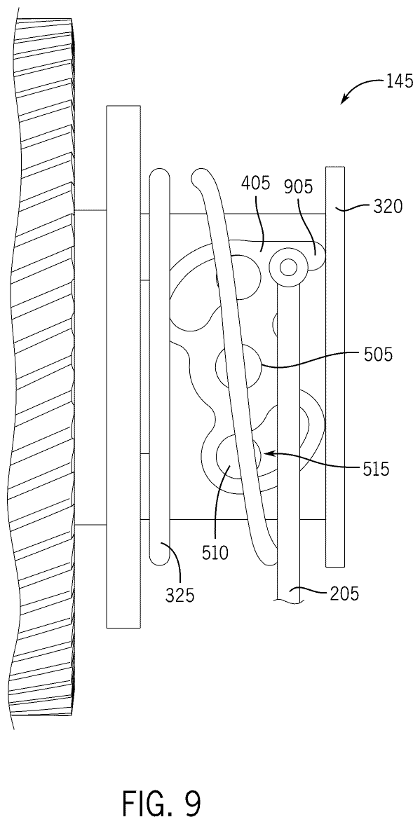

FIG. 9 shows an example of the ejection mechanism 145 in a fully extended position. When fully extended, the ejection rod 215 is configured to extend at least partially through the output end 135 to eject the spline and/or end portion of the fastener. For example, the ejection rod 215 is configured to contact the spine and/or end portion of the fastener to apply a contact force to the spline and/or end portion of the fastener. In one example, to return the ejection mechanism 145 to the home position (e.g., as shown in FIG. 2), the head 320 of the ejection rod 215 contacts a protrusion 905 of the cam plate 405. The head 320 of the ejection rod 215 forces the cam plate 405 into the disengaged position (e.g., so that pawls 310 are not in contact with the ejection rod 215). Thus, the biasing force stored in the biasing element 325 moves the ejection rod 215 back to the home position.

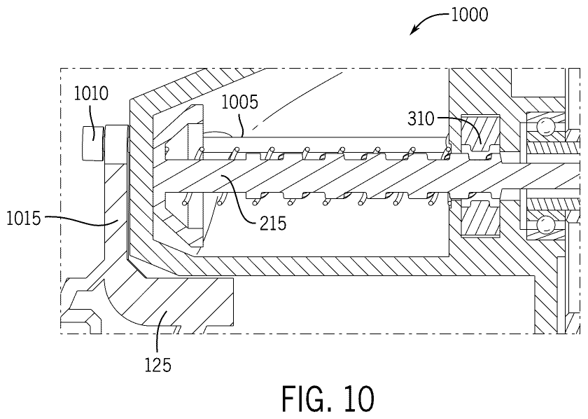

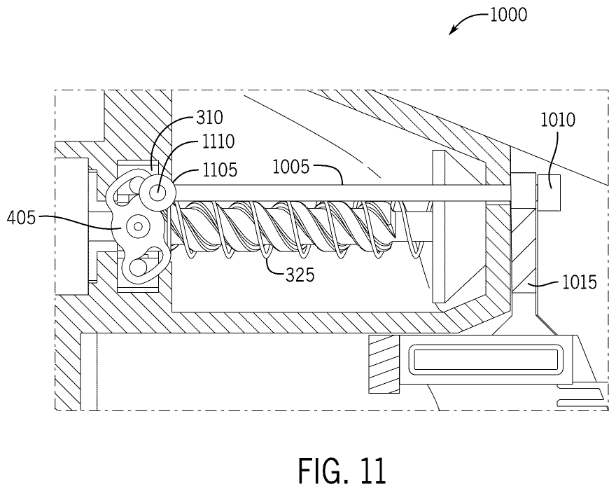

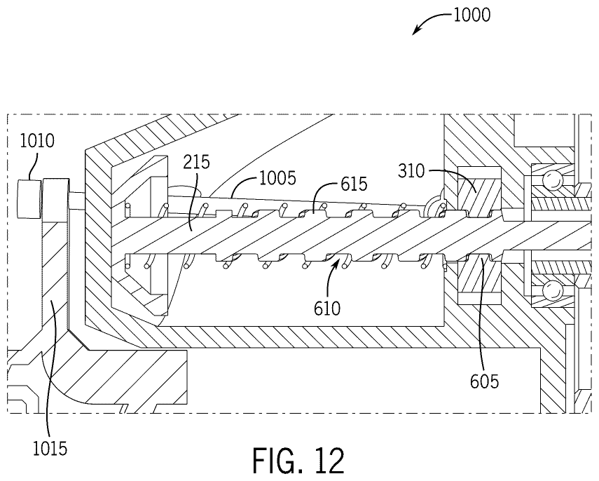

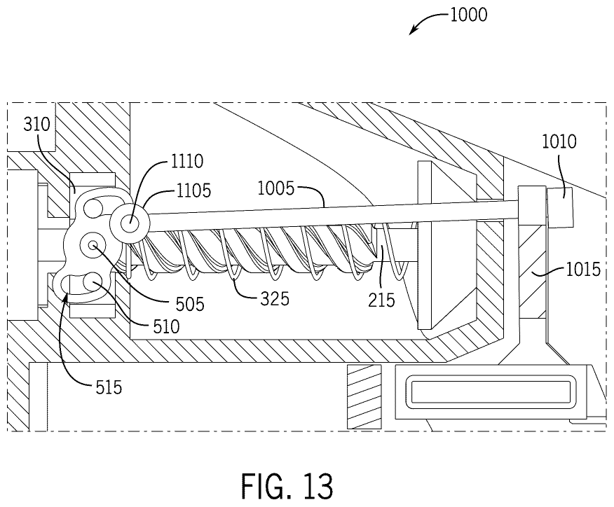

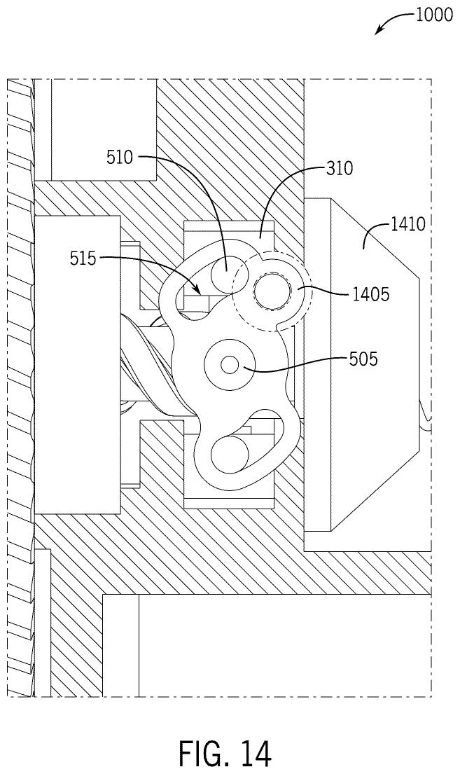

FIGS. 10-14 show another example of an ejection mechanism 1000 for use with the power tool 100. As will be recognized, the ejection mechanism 1000 shares a number of components in common with and operates in a similar fashion to the examples illustrated and described previously. For the sake of brevity as well as clarity, these common features will not be again described below in detail, but please refer to the previous discussion. Only the distinctions between the ejection mechanism 1000 and the examples described previously will be discussed, and unless indicated otherwise, the ejection mechanism 1000 shares similar components and operates in a similar fashion as the examples described previously.

To activate the ejection mechanism 1000 (e.g., actuate the pawls 310 from a disengaged position with respect to the ejection rod 215 to an engaged position via the cam plate 405), the ejection mechanism 1000 includes an engagement rod 1005, which is actuated via a trigger bar 1015 of the secondary trigger 125. In one example, the trigger bar 1015 catches on a head 1010 of the engagement rod 1005 to actuate the engagement rod 1005. For example, the trigger bar 1015 may apply a rearward and/or directional force to the head 1010 of the engagement rod 1005 to actuate the engagement rod 1005.

Actuation of the engagement rod 1005 rotates the cam plate 405 (e.g., in a first direction), which engages the one or more pawls 310 with the ejection rod 215 to enable axial movement of the ejection rod 215. In one example, the engagement rod 1005 includes an engagement latch 1105 at one end. The engagement latch 1105 surrounds and/or engages with an engagement pin 1110, which enables the engagement rod 1005 to rotate the cam plate 405. The ejection rod 215 may include a head 1410 configured to contact a protrusion 1405 extending from the cam plate 405. The head 1410 may be configured to contact the protrusion 1405 when the ejection rod 215 reaches a fully extended state. In one example, the head 1410 pushes against the protrusion 1405 to rotate the cam plate 405 in a second direction, opposite the first direction, which disengages the pawls 310 from the ejection rod 215. Thus, the biasing element 325 may bias the ejection rod 215 into the home position (e.g., as shown in FIG. 10).

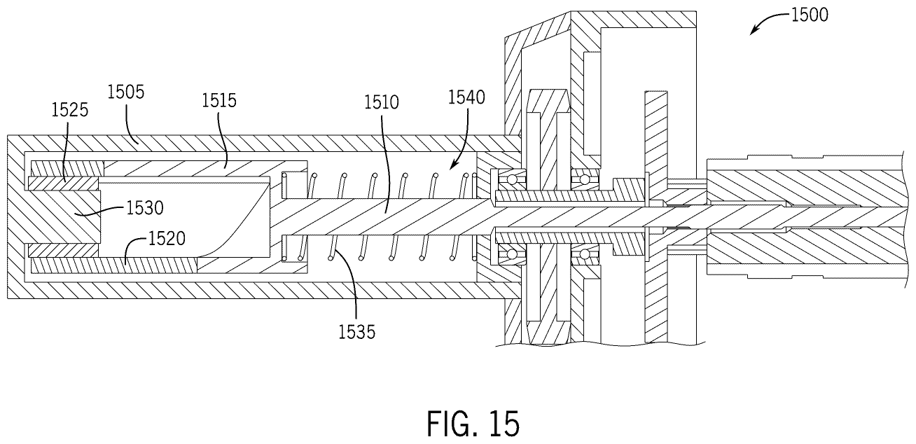

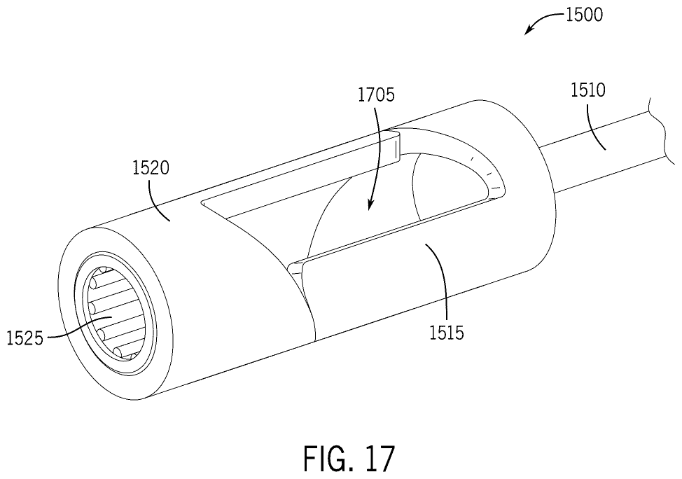

FIGS. 15-17 show another example of an ejection mechanism 1500 for use with the power tool 100. The ejection mechanism 1500 includes a housing 1505 configured to surround an ejection rod 1510. In one example, the ejection rod 1510 includes a first cam face 1515 at one end, which engages with a second cam face 1520. The second cam face 1520 may be rotationally mounted to a one-way clutch 1525. In one example, the one-way clutch 1525 may be a sprag bearing. The one-way clutch 1525 may enables unidirectional rotation of the second cam face 1520. For example, the second cam face 1520 may rotate freely in a first direction (e.g., clockwise direction) and be prevented from rotation (e.g., locked) in a second direction (e.g., counterclockwise direction). In one example, the one-way clutch 1525 surrounds and/or is mounts to a portion of the housing 1505, for example, a retention shaft 1530 of the housing 1505.

In one example, the ejection mechanism 1500 rotates freely as a unitary system (e.g., the first cam face and second cam face rotate together) when rotating in the first direction. For example, the first and second cam faces 1515, 1520 each include a parallel ledge that locks the cam faces together to form a unitary system when rotating in the first direction (e.g., the free rotation direction as dictated by the one-way clutch). However, rotation of the ejection rod 1510 in the second, opposite direction, locks against rotation of the second cam face 1520, via the one-way clutch 1525. In this case, the first cam face 1515 continues to rotate as the second cam face 1520 remains stationary. Thus, a first sloped portion 1605 of the second cam face 1520 and a second sloped portion 1610 of the first cam face 1515 to slide against each other generating a gap 1705 between the first cam face 1515 and the second cam face 1520. In one example, the gap 1705 corresponds to an amount of axial movement of the ejection rod 1510. Thus, continued rotation of the first cam face in the second direction generates further axial movement in the ejection rod 1510, until the ejection rod 1510 contacts a splined portion and/or end of a fastener, which applies a contact force to the portion of the fastener until ejection of the portion of the fastener.

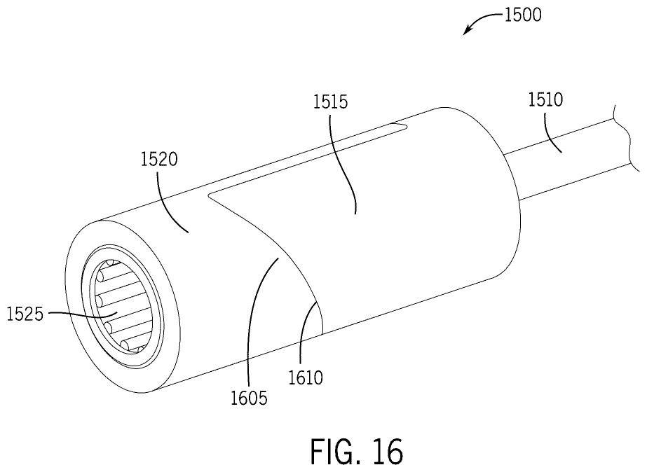

In one example, after axial movement of the first cam face 1515 compresses a biasing element 1535 within an opening 1540 defined by the housing. The biasing element 1535 may surround the ejection rod 1510 such that axial movement of the ejection rod 1510 increases a biasing force in the biasing element 1535. Thus, after ejection of the end and/or splined portion of the fastener the biasing element forces the ejection rod to return to the home position with the first cam face and the second cam face engaged (e.g., as shown in FIG. 16). In one example, the biasing element 1535 may be a spring. In other examples, the biasing element 1535 may be an elastic material, such as rubber and/or another elastic material.

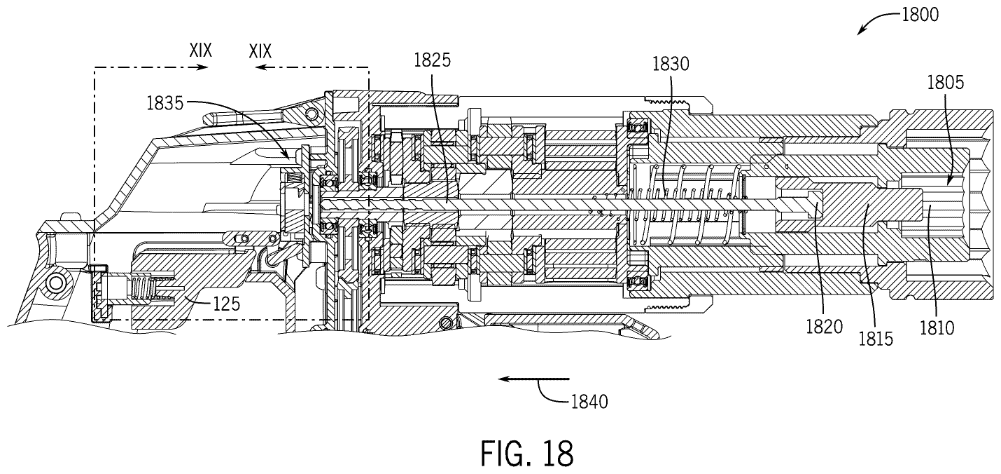

FIG. 18 shows another example of an ejection mechanism 1800 for use with the power tool 100. In one example, the ejection mechanism 1800 may primed and/or prepared by the insertion of a splined and/or end portion of a fastener into an inner socket 1805 of the tool. For example, insertion of the splined and/or end portion of the fastener into the inner socket 1805 may apply a force to an endcap 1810 of a plunger 1815 within the tool. In one particular example, the force from the splined portion of the fastener may push the plunger 1815 rearward (e.g., in the direction shown by arrow 1840 to move away from the output end), which correspondingly actuates an ejection rod 1825 rearward into contact with a locking assembly 1835. In one example, the ejection rod 1825 may be biased rearward against the biasing force of a biasing element 1830, which generates an increasing biasing force within the biasing element 1830.

In one example, the locking assembly 1835 may retain and/or hold the ejection rod 1825 in the rearward portion (e.g., locked position) until a user actuates the secondary trigger 125 to release the ejection rod 1825 from the locking assembly 1835. Once the user releases the ejection rod 1825 from the locking assembly 1835 (e.g., by pressing the secondary trigger 125) the ejection rod 1825 is biased forwards via the biasing element 1830 such that a head 1820 of the ejection rod 1825 contacts the plunger 1815 and applies a contact force to the spline of the fastener. Thus, the spline of the fastener may be released and/or ejected from the inner socket 1805 via an impulse force imparted into the spline from the ejection rod 1825 (i.e., from ejection rod into the plunger 1815) via the biasing element 1830. In one example, the biasing element 1830 may be a spring. In other examples, the biasing element 1830 may be an elastic material, such as rubber and/or another clastic material.

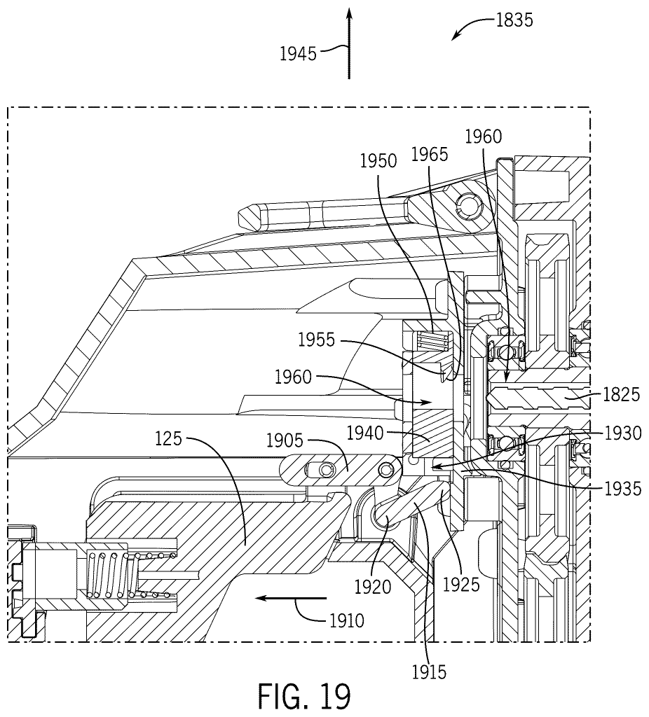

FIG. 19 shows partial view of the ejection mechanism 1800 including the locking assembly 1835. As described previously, the locking assembly 1835 may be configured to selectively lock and/or unlock movement of the ejection rod 1825 once primed. For example, the locking assembly 1835 may be configured to release the ejection rod 1825 to apply a force to the spline portion of the fastener to eject the fastener from the tool.

In one example, the locking assembly 1835 is configured to automatically lock the ejection rod 1825 into position when the ejection rod 1825 is moved rearward via the spline as discussed previously. For example, the locking assembly 1835 may include a biasing element 1950 configured to bias a tooth 1955 of a locking pawl 1940 into contact with one or more channels 1960 on the ejection rod 1825. The tooth 1955 may include a chamfered surface 1965, which is configured to enable unidirectional movement of the ejection rod 1825 into the locking assembly 1835 (e.g., in the direction shown by arrow 1910. Once the ejection rod 1825 has moved rearward, the biasing element 1950 is configured to bias the tooth 1955 into the channel 1960 of the ejection rod 1825 to lock movement of the ejection rod (in a direction opposite that of arrow 1910).

To unlock forward movement of the ejection rod 1825 and eject the spline of the fastener, the secondary trigger 125 is pulled by a user, which actuates a trigger bar 1905 in a rearward direction (e.g., direction of arrow 1910). As the trigger bar 1905 actuates rearward, a (bell-crank) linkage 1915 connected to the trigger bar 1905 rotates about a pivot point 1920 such that an end 1925 of the linkage 1915 protrudes through an opening 1930 defined by a housing 1935. As the end 1925 of the linkage 1915 protrudes through the opening 1930, the end 1925 contacts the locking pawl 1940, which actuates the locking pawl 1940 upwards (e.g., in the direction shown by arrow 1945) against the force of the biasing element 1950. As the locking pawl 1940 is moved upwards (in the direction of arrow 1945) the tooth 1955 is disengaged from the ejection rod 1825, which releases the ejection rod 1825. As was described previously, releasing the ejection rod 1825 causes the head 1820 of the ejection rod to move forwards (e.g., via the biasing element 1830) and contact the plunger 1815 to generate an impulse force to eject the spline of the fastener from the power tool 100.

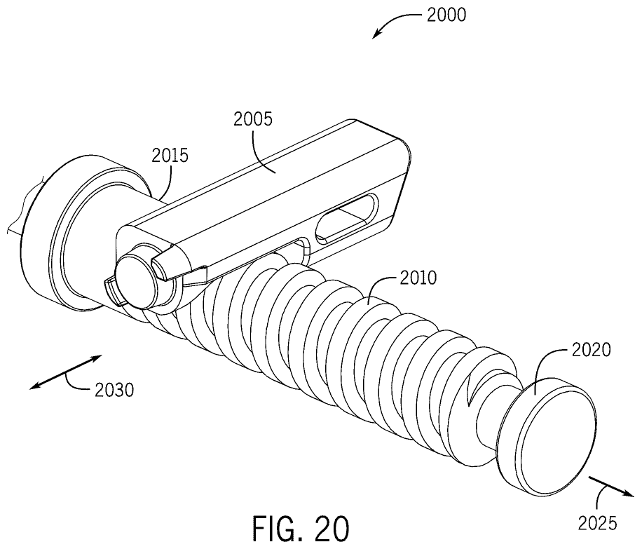

FIG. 20 shows another example of an ejection mechanism 2000 for use with the power tool 100. The ejection mechanism 2000 includes a shuttle 2005 configured to selectively interact (e.g., mesh) with one or more threads 2010 on a shaft 2035 of an ejection rod 2015. In one example, the shuttle 2005 may be actuated via a trigger, button, or other actuator on the power tool 100 between a first position, where the shuttle 2005 is disengaged from the ejection rod 2015, and a second position, where the shuttle 2005 is engaged with the ejection rod 2015. For example, the shuttle 2005 may be actuated in the direction shown by arrow 2030.

In one example, when the shuttle 2005 is actuated into the second position, the shuttle may engage the threads 2010 of the ejection rod 2015, which may elicit movement of a first end 2020 of the ejection rod 2015 in the direction shown by arrow 2025 (e.g., axially along an axis formed by the ejection rod). Thus, as the ejection rod 2015 moves in the direction shown by arrow 2025, the first end 2020 of the ejection rod 2015 may engage a spline or other component of a fastener within a socket of the power tool 100 to eject (e.g., remove) the spline from within the socket.

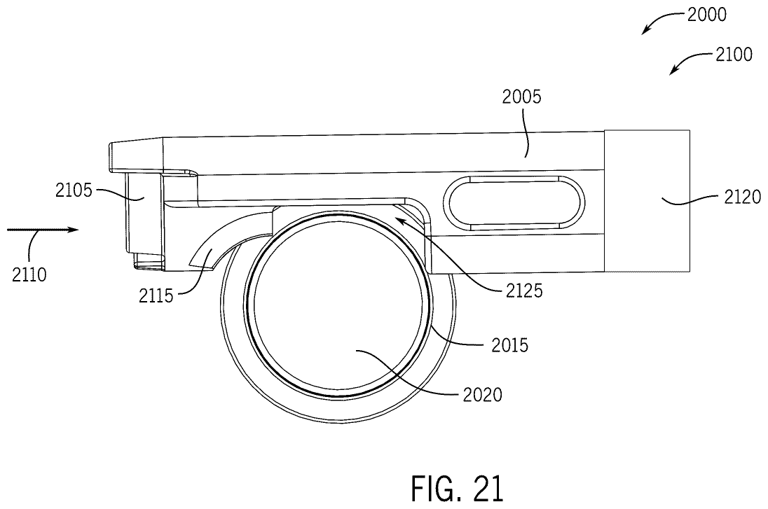

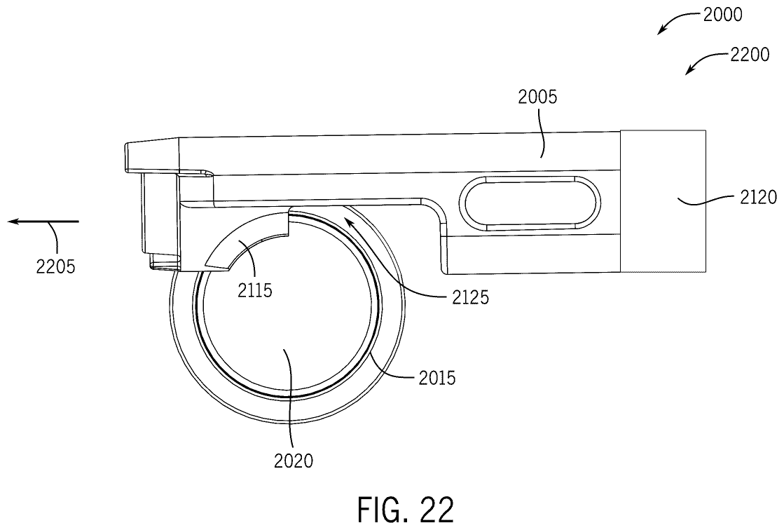

FIGS. 21 and 22 show the ejection mechanism 2000 in the first, disengaged position 2100 and the second, engaged position 2200, respectively. When in the first position 2100, the shuttle 2005 is arranged so that a threaded section 2115 of the shuttle is disengaged (e.g., free from contact with) the ejection rod 2015. Put differently, a cutout 2125 of the shuttle 2005 is positioned around, but not contacting the ejection rod 2015. However, as mentioned previously, when an operator actuates a trigger, button, or other actuator on the power tool 100, a force may be applied to the shuttle 2005 (e.g., to an end 2105 of the shuttle 2005) as shown by arrow 2110. This force (e.g., as shown by arrow 2110) may move the shuttle 2005 against the biasing force of a biasing element 2120 into the second, engaged position 2200.

In the second, engaged position 2200, the threaded section 2115 of the shuttle 2005 is engaged (e.g., in contact with) the ejection rod 2015 (e.g., via the threads). As a result, the ejection rod 2015 may actuate forwards (e.g., as shown by arrow 2030) to eject a spline from the power tool 100. In one example, the ejection rod 2015 may continue forward movement as long as an operator maintains actuation of the button, trigger, or other actuator. Thus, when the operator releases the button, trigger, or other actuator, the biasing element 2120 (e.g., a spring), may force the shuttle 2005 out of the second position 2200 into the first position 2100. Further, once the shuttle 2005 is disengaged from the ejection rod 2015 (e.g., in the first position 2100), the ejection rod 2015 may be automatically returned to a home (e.g., default) position via a biasing element (e.g., a spring or other biasing element).

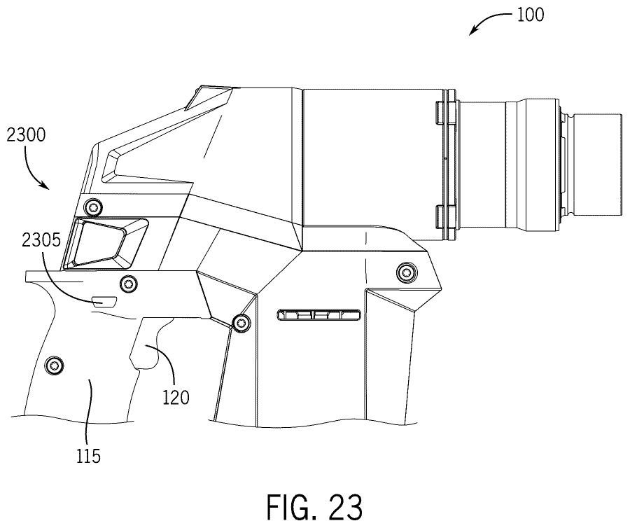

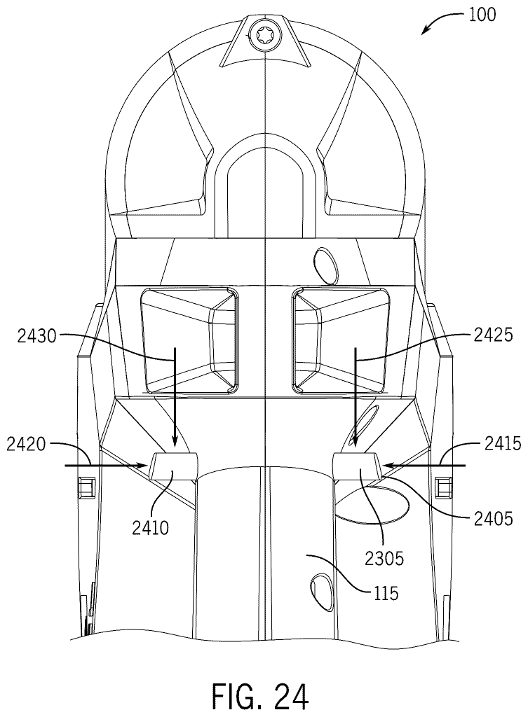

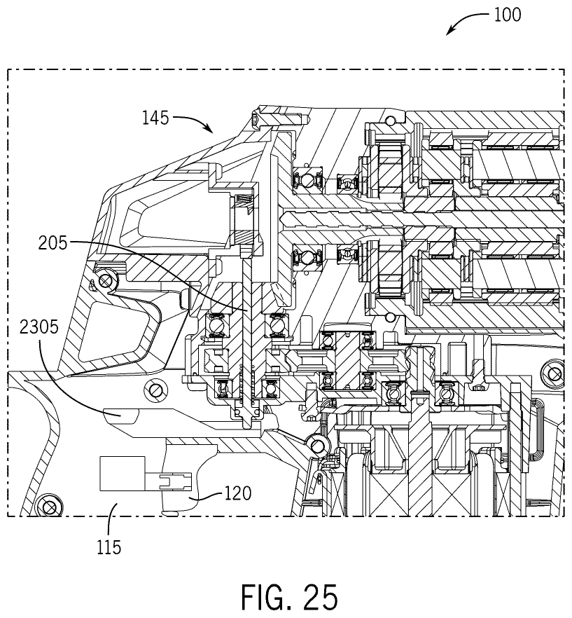

FIGS. 23-25 show an example of the power tool 100 including another example of an ejection mechanism actuator 2300 (e.g., in lieu of the secondary trigger 125). For example, instead of the secondary trigger 125 (e.g., as shown in FIG. 1), the power tool 100 may include a selector switch 2305 on the handle 115. The selector switch 2305 may permit an operator to engage the ejection mechanisms described previously by actuating the selector switch 2305 from a first side 2405 and/or a second side 2410. In some cases, the selector switch 2305 can be a bi-directional selector switch.

For example, the operator may apply a force in the direction shown by arrow 2415 to the first side 2405 to engage the ejection mechanism (e.g., via engagement between the selector switch 2305 and the linkage shaft 205). Further, the operator may apply a force in the direction shown by arrow 2425 to the first side 2405 to engage the ejection mechanism. Alternatively or additionally, the operator may apply a force in the direction shown by arrow 2420 to the second side 2410 to engage the ejection mechanism. Correspondingly, the operator may apply a force in the direction shown by arrow 2430 to the second side 2410 to engage the ejection mechanism.

Thus, the operator may have a variety of directional actuation options when attempting to engage the ejection mechanism via the selector switch 2305. In one example, the selector switch 2305 may remain in an actuated position (corresponding to engagement of the ejection mechanism) until the operator actuates the selector switch 2305 back into a home (e.g., default position, corresponding to disengagement of the ejection mechanism). In other examples, the selector switch 2305 may be spring biased so that an operator needs to hold the selector switch 2305 in the desired position to engage the ejection mechanism, and when the operator releases the selector switch the selector switch 2305 may return to the home (e.g., default position).

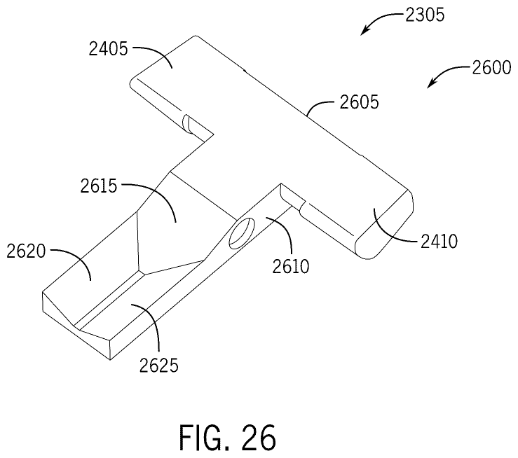

FIG. 26 illustrates an example of a selector 2600 of the selector switch 2305. As shown, the selector 2600 may include a head 2605 including both the first side 2405 and the second side 2410. Extending away from the head 2605 may be a shaft 2610, which may include a variety of angled faces, which may contact the linkage shaft 205 to engage the ejection mechanism.

In one example, the selector 2600 may define a T-shaped profile, which permits an operator to actuate both the first and second sides 2405, 2410 when the selector 2600 is arranged within the handle 115 of the power tool 100.

In another example, the angled faces of the shaft 2610 may each be configured to actuate the linkage shaft 205 based on the direction of actuation of the selector switch 2305. For example, the shaft 2610 may include a first angled face 2615 configured to contact and engage the linkage shaft 205 when the first side 2405 or the second side 2410 of the selector 2600 is actuated in the direction shown by arrows 2425, 2430. Correspondingly, the shaft 2610 may include a second angled face 2620 configured to contact and engage the linkage shaft 205 when the first side 2405 of the selector 2600 is actuated in the direction shown by arrow 2415. Additionally, the shaft 2610 may include a third angled face 2625 configured to contact and engage the linkage shaft 205 when the second side 2410 of the selector 2600 is actuated in the direction shown by arrow 2420.

Thus, the use of the selector 2600 may permit an operator to engage the ejection mechanism by actuating the selector 2600 from a variety of different positions, which may increase overall working efficiency for the operator.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An ejection mechanism for a power tool, the ejection mechanism comprising:
an ejection rod having a threaded shaft;
a cam plate that is selectively actuated between a first position and a second position; and
a pawl engaged with the cam plate, the pawl being disengaged from the threaded shaft of the ejection rod when the cam plate is in the first position and being engaged with the threaded shaft of the ejection rod when the cam plate is in the second position to cause the ejection rod to axially actuate from a first axial position to a second axial position.

2. The ejection mechanism of claim 1, wherein the ejection rod is rotated by a motor of the power tool.

3. The ejection mechanism of claim 1 further comprising:
a biasing element surrounding a portion of the ejection rod and positioned between a head of the ejection rod and a cam assembly of the ejection mechanism, the biasing element providing a biasing force to return the ejection rod from the second axial position to the first axial position.

4. The ejection mechanism of claim 1 further comprising:
an actuator that engages the ejection mechanism; and
a linkage shaft connected between the actuator and the ejection mechanism.

5. The ejection mechanism of claim 4, wherein the actuator is a trigger.

6. The ejection mechanism of claim 4, wherein the actuator is a selector switch.

7. The ejection mechanism of claim 6, wherein the selector switch includes a selector having a head and a shaft, the shaft including an angled surface that engages the ejection mechanism.

8. An ejection mechanism for a power tool, the ejection mechanism comprising:
an ejection rod including a first cam face;
a second cam face coupled to a one-way clutch to permit unidirectional rotation of the second cam face so that rotation of the ejection rod in a first direction rotates both the first cam face and the second cam face together and rotation of the ejection rod in a second direction rotates the first cam face and locks rotation of the second cam face to cause the ejection rod to actuate; and
a biasing element that biases the first cam face into engagement with the second cam face.

9. The ejection mechanism of claim 8, wherein each of the first cam face and the second cam face includes a sloped portion, and wherein rotation of the ejection rod in the second direction causes the sloped portion of the first cam face to slide against the sloped portion of the second cam face to actuate the ejection rod against a biasing force of the biasing element.

10. The ejection mechanism of claim 9, wherein the biasing element returns the ejection rod to a home position after ejection of an end portion of a fastener.

11. The ejection mechanism of claim 8 further comprising a trigger that selectively engages the ejection mechanism.

12. The ejection mechanism of claim 8 further comprising a selector switch that selectively engages the ejection mechanism.

13. The ejection mechanism of claim 12, wherein the selector switch includes a selector having a head portion and a shaft portion, the shaft portion including an angled surface to engage the ejection mechanism.

14. A power tool, comprising:
an electric motor;
an ejection mechanism including:
an ejection rod having threaded shaft with a first end opposite a second end, and
a shuttle moveable between a first position and a second position, the shuttle defining a cutout having a threaded portion; and
an actuator that moves the shuttle between the first position, where the threaded portion of the cutout is disengaged from the threaded shaft, and the second position, where the threaded portion of the cutout is engaged with the threaded shaft.

15. The power tool of claim 14, wherein the shuttle engages the threaded shaft of the ejection rod in the second position to axially advance the first end of the ejection rod.

16. The power tool of claim 15, wherein the electric motor rotates the ejection rod to advance the first end of the ejection rod.

17. The power tool of claim 14, wherein the actuator is a trigger.

18. The power tool of claim 14, wherein the actuator is a selector switch.

19. The power tool of claim 18, wherein the selector switch includes a selector having a head portion and a shaft portion, the shaft portion including an angled surfaces to engage the ejection mechanism.

20. The power tool of claim 14 further comprising a biasing element that biases the shuttle into the first position.
